(19) United States
(12) Patent Application Publication
(10) Pub. No.: US 2003/0046054 A1
(43) Pub. Date: Mar. 6, 2003

(54) Providing modeling instrumentation with an application programming interface to a GUI application

(76) Inventors: William R. Wheeler, Southborough, MA (US); Matthew J. Adiletta, Worcester, MA (US); Timothy J. Fennell, Holliston, MA (US)

Correspondence Address: FISH & RICHARDSON, PC, 4350 LA JOLLA VILLAGE DRIVE, SUITE 500, SAN DIEGO, CA, 92122, US

(21) Appl. No.: 10/007,007

(22) Filed: Dec. 4, 2001

Related U.S. Application Data
(60) Provisional application No. 60/315,852, filed on Aug. 29, 2001.

(51) Int. Cl. G06F 17/50

(52) U.S. Cl. 703/15

(57) ABSTRACT

Providing instrumentation data relating to a logic design element generally includes using a logic design element in a logic design, performing a simulation of the logic design that includes simulating the logic design element, and having the logic design element automatically collect the instrumentation data during the simulation, where the instrumentation data relate to the logic design element. A query may be received to display the instrumentation data relating to the logic design element and the instrumentation data relating to the logic design element may be displayed in response to the query.

### CROSS-REFERENCE TO RELATED APPLICATIONS

This application claims priority from U.S. Provisional Application No. 60/315,852, filed Aug. 29, 2001, and titled “Visual Modeling and Design Capture Environment,” which is incorporated by reference.

### TECHNICAL FIELD

This invention relates to providing modeling instrumentation with an application programming interface to a graphical user interface (GUI) application.

### BACKGROUND

The logic design process includes selecting logic design elements that are appropriate for a particular logic design. For example, a logic design element that is sized inappropriately may waste valuable silicon area on the chip if sized too large or may create undesirable latencies if sized too small.

### DESCRIPTION OF DRAWINGS

FIG. 1 is a block diagram of a computer system.

FIG. 2 is a flow chart of a process for providing instrumentation data relating to a logic design element.

FIG. 3A is a block diagram of a logic design including a FIFO memory.

FIG. 3B is a block diagram of a display of instrumentation data relating to the FIFO memory of FIG. 3A.

FIG. 4A is a block diagram of a logic design including a tri-state bus.

FIG. 4B is a block diagram of a display of instrumentation data relating to the tri-state bus of FIG. 4A.

Like reference symbols in the various drawings indicate like elements.

### DETAILED DESCRIPTION

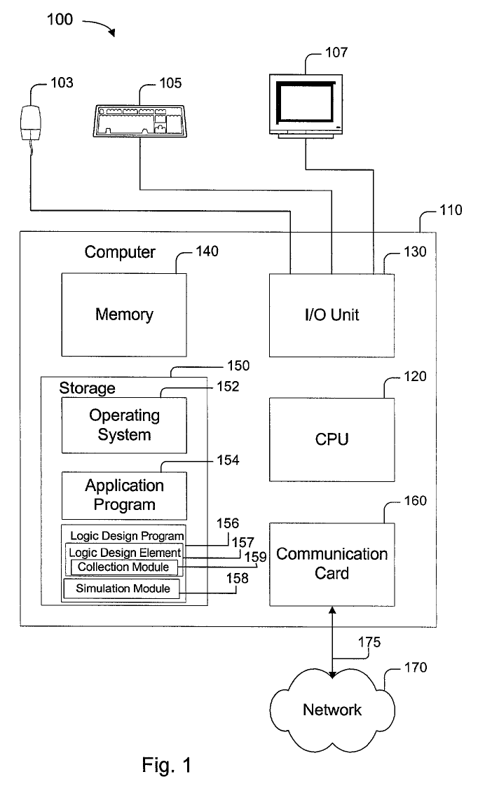

FIG. 1 illustrates an exemplary system 100 such as a computer system that may be used in the logic design process. The system 100 may include various input/output (I/O) devices (e.g., mouse 103, keyboard 105, and display 107) and a general purpose computer 110 having central processor unit (CPU) 120, I/O unit 130, memory 140, and storage 150. Storage 150 may store machine-executable instructions, data, and various programs such as an operating system 152, one or more application programs 154, and one or more logic design programs 156, all of which may be processed by CPU 120.

System 100 also may include a communications card or device 160 (e.g., a modem and/or a network adapter) for exchanging data with a network 170 using a communications link 175 (e.g., a telephone line, a wireless network link, a wired network link, or a cable network). Other examples of system 100 may include a handheld device, a workstation, a server, a device, a component, other equipment, or some combination of these capable of responding to and executing instructions in a defined manner.

System 100 may be arranged to operate in concert with one or more similar systems to facilitate the logic design process. The logic design process may include different tasks, such as, for example, design, capture, documentation, compilation, simulation, and debug. The system 100 includes a logic design program 156 stored in storage 150 and used during the logic design process. The logic design program 156 includes one or more logic design elements 157 that are used to create logic designs. Logic design elements may include, for example, state elements, combinatorial elements, tri-state devices and drivers, data buses (e.g., tri-state buses), memory components (e.g., first-in/first-out (FIFO) memory), clocks, and other elements commonly found in a logic design.

The logic design program 156 also includes various stand-alone and/or integrated modules for completing one or more of the logic design tasks, such as, for example, a simulation module 158. The simulation module 158 typically includes a graphical user interface (GUI) component and may be used to generate and run various simulation scenarios that test the performance of the logic design elements used in a particular logic design.

A simulation scenario may include performing an operation that exercises all or a portion of the logic design including particular logic design elements or combinations of logic design elements. For instance, an exemplary simulation may be the transfer of data from one logic design element or combination of logic design elements in the logic design across one or more data buses to another logic design element or combination of logic design elements.

The logic design elements 157 each include an integrated collection module 159 that automatically collects instrumentation data relating to the logic design elements that are exercised during a simulation. The collection module 159 typically includes an application programming interface (API) to interface with the simulation module 158. The collection module 159 may collect the instrumentation data for a particular simulation and/or may collect and store the instrumentation data for more than one consecutive or non-consecutive simulation. The instrumentation data collected by the collection module 159 includes various usage and performance related statistics relating to a particular logic design element or portions of the particular logic design element.

The logic design program 156 also may include an interface module (not shown) that interfaces with the other components of system 100 and is capable of receiving a query to display the instrumentation data. A display module (not shown) may interface with display 107 of FIG. 1 to display the instrumentation data in response to a received query.

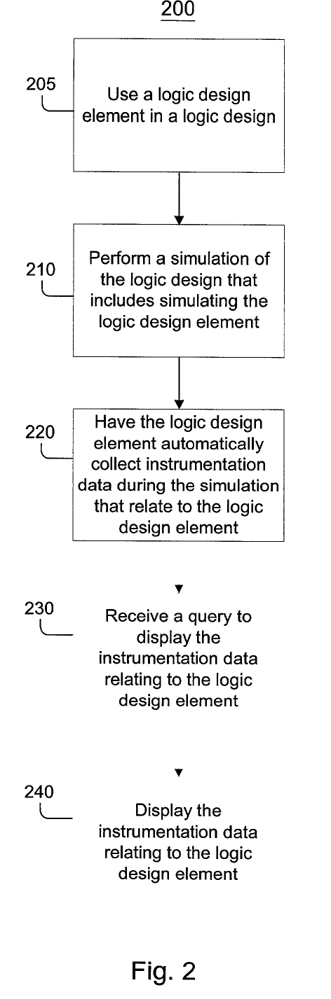

FIG. 2 illustrates an exemplary process 200 for providing instrumentation data relating to a logic design element. Process 200 typically includes using a logic design element in a logic design (205), performing a simulation of a logic design that includes simulating the logic design element (210), and having the logic design element automatically collect instrumentation data during the simulation (220). The instrumentation data may be collected by the logic design element (220) whenever a simulation is performed (210). There is no need to create a separate model or computer program to collect the instrumentation data for a particular logic design element in a particular simulation. various simulations may be performed (210) that involve exercising the logic design element in numerous scenarios, and logic designers and architects may use the instrumentation data collected during the various simulations (220) to make design choices relating to the logic design element.

Process 200 also includes receiving a query to display the instrumentation data relating to the logic design element (230) and displaying the instrumentation data (240). A query may include a text command or other action, such as any action that selects a particular logic design element.

The instrumentation data may be displayed (240) at various times during or after the simulation process. For example, the instrumentation data may be displayed (240) while performing the simulation (210), automatically at the end of performing the simulation, or in response to a query (230) either during or after performing the simulation. In one implementation, for instance, a partial simulation may be performed (210) and the instrumentation data may be collected (220) and displayed (240) for one or more particular logic design elements that were exercised during the partial simulation.

In one implementation, a logic design element includes a FIFO memory and process 200 includes using the FIFO memory in a logic design (205), performing a simulation (210) that exercises the FIFO memory, and having the FIFO memory automatically collect instrumentation data that relates to the FIFO memory (220). In response to a query (230), the instrumentation data are displayed (240).

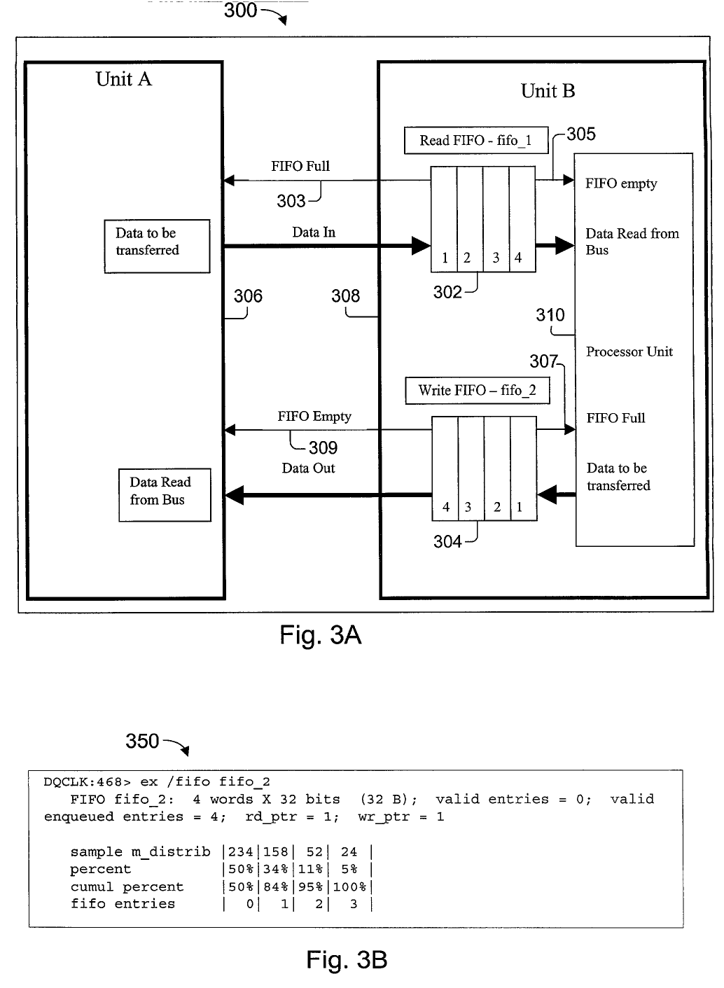

A FIFO memory is a memory device in which data are read from the device in the same order as the data are written to the device. FIG. 3A illustrates an exemplary logic design 300 that includes a FIFO memory 302 labeled “fifo_{—}1” and a FIFO memory 304 labeled “fifo_{—}2”, each of which are sized to be 4 words by 32 bits. The logic design 300 also includes logic design element “Unit A” 306, logic design element “Unit B” 308, and a processor unit 310.

In this example, a simulation is performed (210) in which data are being transferred from Unit A 306 to Unit B 308, the data are processed at Unit B by processor unit 310 to produce processed data, and the processed data are transferred from Unit B 308 to Unit A 306.

Unit A 306 sends data to FIFO memory 302 as long as the FIFO full flag 303 is not set. When the FIFO full flag 303 is set, Unit A 306 must wait for the processor unit 310 to read data from FIFO memory 302. The processor unit 310 reads the data from FIFO memory 302, processes the data, and transfers the processed data to FIFO memory 304. The processor unit 310 may read data from FIFO memory 302 as long as the FIFO empty flag 305 is not set. When the FIFO empty flag 305 is set, the processor unit 310 must wait for data to be transferred from Unit A 306 to FIFO memory 302.

Unit A 306 reads the processed data from FIFO memory 304 within Unit B 308. The processor unit 310 may write data to FIFO memory 304 as long as the FIFO full flag 307 is not set. When the FIFO full flag 307 is set, processor unit 310 must wait for Unit A 306 to read data from FIFO memory 304. Unit A 306 may read data from FIFO memory 304 as long as the FIFO empty flag 309 is not set. When the FIFO empty flag 309 is set, Unit A must wait for data to be transferred from the processor unit 310 to FIFO memory 304.

During the simulation (210), instrumentation data relating to FIFO memory 302 are collected by FIFO memory 302 (220) and instrumentation data relating to FIFO memory 304 are collected by FIFO memory 304 (220). For example, the instrumentation data may include usage and performance statistics relating to the degree of fullness of the FIFO memory 302 and the FIFO memory 304 during the simulation.

FIG. 3B illustrates the instrumentation data 350 collected during an exemplary simulation exercising the FIFO memory 304. In this example, the instrumentation data 350 include identifying data about the particular FIFO memory 304 such as a label and its size. In this instance, the FIFO memory 304 is labeled “fifo_{—}2” and its size is 4 words by 32 bits.

The instrumentation data 350 are divided into four columns corresponding to the four words of the FIFO memory 304. The columns indicate the number of times a particular word in the FIFO memory 304 was exercised during the simulation. In this exemplary simulation, multiple entries were written into and read out of the FIFO memory 304. This particular table divides the 4 words into 4 columns labeled 0-3. The “sample m_distrib” row indicates the number of entries in a particular word during the simulation (e.g., the number of writes and reads for a particular word). The instrumentation data 350 include statistics such as “percent,” which indicates the percentage of time a particular word was in use during the simulation, and “cumul percent,” which is a running cumulative percentage of the words. Other instrumentation data 350 are included such as the number of valid entries, the number of valid enqueued entries, and the number of read and write pointers.

Logic designers and architects may use the instrumentation data to determine if the appropriate logic design element is being used in the logic design. For instance, the instrumentation data may indicate that the FIFO memory may be too small and not able to handle the system load or that the FIFO memory may be too large such that it wastes valuable silicon area on the chip.

In another implementation, a logic design element may include a tri-state bus and process 200 may include using the tri-state bus in a logic design (205), performing a simulation that exercises the tri-state bus (210), and having the tri-state bus automatically collect instrumentation data related to the tri-state bus (220). In response to a query (230), the instrumentation data are displayed (240).

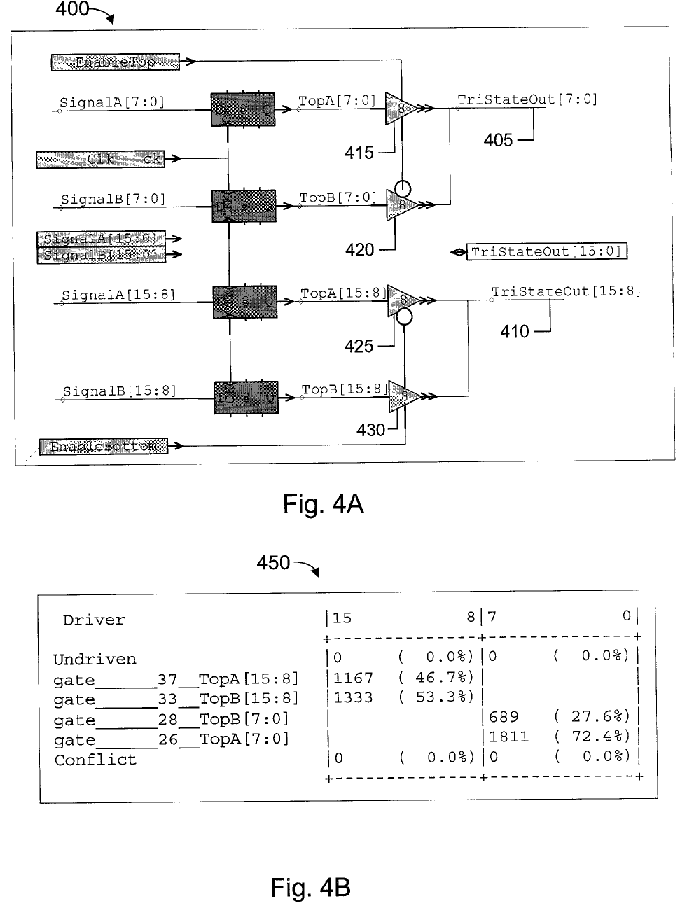

FIG. 4A illustrates a logic design circuit 400 that includes a tri-state bus 405, 410 and four tri-state drivers 415, 420, 425, 430 that are driven in pairs. A tri-state bus is a data bus shared by multiple devices only one of which has its drivers enabled at any instant and the rest of which are disabled in an open state. In this example, the tri-state bus is a 16 bit bus that includes a lower bit range portion 405 to which two tri-state drivers 415, 420 are connected and an upper bit range portion 410 to which two tri-state drivers 425, 430 are connected.

The top pair of tri-state drivers 415, 420 have inverted enables so that when the tri-state driver 415 for “TopA [7:0]” is enabled, the tri-state driver 420 for “TopB [7:0]” is disabled, and vice versa. If the two enables for the tri-state drivers 415, 420 were driven at the same time, bus contention would occur because both of the tri-state drivers 415, 420 would be attempting to drive the same bit range “TriStateOut [7:0]” of the tri-state bus 405. Bus contention is an error condition that occurs when more than one tri-state driver drives the same bit range of the bus at the same time. Another error condition may occur when there are no tri-state drivers driving the bus. This “undriven” state may be an error condition because a device attempting to read the tri-state bus may read data from an unknown source or it may be unclear to the device what, if anything, is being read from the tri-state bus.

The bottom two tri-state drivers 425, 430 drive the upper bits 410 (labeled “TriStateOut [15:8]”) of the tri-state bus and, accordingly, do not conflict with the tri-state drivers 415, 420 described above. The enables for the two tri-state drivers 425, 430 are inverted from each other so that they will not create bus contention on the tri-state bus portion 410.

FIG. 4B illustrates the instrumentation data 450 that results following an exemplary simulation of the logic circuit 400 of FIG. 4A. In this exemplary simulation, a simulator module simulated 2500 cycles while generating random values for “EnableTop” and “EnableBottom.” The instrumentation data includes a row for each tri-state driver 415 (gate_{—}26_TopA [7:0]), 420 (gate_{—}28_TopB [7:0]), 425 (gate_{—}37_TopA [15:8]), and 430 (gate_{—}33_TopB [15:8]), and a row for each potential tri-state bus error condition labeled “Undriven” and “Conflict.”

The two columns indicate the bit range for the tri-state bus portions 405, 410. In this instance, during the 2500 cycle simulation no bus errors occurred as evidenced by the “0” entries in the “Undriven” and “Conflict” rows.

The instrumentation data 450 include statistics relating to the number of simulation cycles and the percentage of time a particular tri-state driver was driving the tri-state bus. The instrumentation data also indicate the number of simulation cycles and the percentage of time that a bus error, for example, “Undriven” or “Conflict,” occurred during the simulation. Logic designers and architects may use the instrumentation data to make logic design choices related to tri-states buses, especially relating to situations where bus errors may occur.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor.

A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of nonvolatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made. For example, advantageous results still could be achieved if steps of the disclosed techniques were performed in a different order and/or if components in the disclosed systems were combined in a different manner and/or replaced or supplemented by other components. For instance, instrumentation data may be automatically collected during simulations for logic design elements in addition to those described above. Accordingly, other implementations are within the scope of the following claims.

What is claimed is:

1. A method comprising:
using a logic design element in a logic design;
performing a simulation of the logic design that includes simulating the logic design element; and
having the logic design element automatically collect instrumentation data during the simulation, wherein the instrumentation data relate to the logic design element.

2. The method of claim 1 further comprising displaying the instrumentation data relating to the logic design element.

3. The method of claim 2 further comprising receiving a query to display the instrumentation data relating to the logic design element, wherein displaying the instrumentation data includes displaying the instrumentation data relating to the logic design element in response to the query.

4. The method of claim 2 wherein displaying the instrumentation data includes displaying the instrumentation data after performing the simulation.

5. The method of claim 2 wherein displaying the instrumentation data includes displaying the instrumentation data while performing the simulation.

6. The method of claim 2 wherein:
performing the simulation includes performing a partial simulation,
having the logic design element automatically collect the instrumentation data includes having the logic design element automatically collect the instrumentation data during the partial simulation, and
displaying the instrumentation data includes displaying the instrumentation data after performing the partial simulation.

7. The method of claim 1 wherein:
the logic design element includes a FIFO memory, and
having the logic design element automatically collect the instrumentation data includes having the FIFO memory automatically collect the instrumentation data during the simulation, with the instrumentation data relating to the FIFO memory.

8. The method of claim 7 wherein having the FIFO memory automatically collect the instrumentation data includes having the FIFO memory record usage of the FIFO memory during the simulation.

9. The method of claim 7 further comprising:
receiving a query to display the instrumentation data relating to the FIFO memory, and
displaying the instrumentation data relating to the FIFO memory in response to the query.

10. The method of claim 1 wherein:
the logic design element includes a tri-state bus, and
having the logic design element automatically collect the instrumentation data includes having the tri-state bus automatically collect the instrumentation data during the simulation, with the instrumentation data relating to the tri-state bus.

11. The method of claim 10 wherein having the tri-state bus automatically collect the instrumentation data includes having the tri-state bus automatically collect usage of the tri-state bus during the simulation.

12. The method of claim 10 further comprising:
receiving a query to display the instrumentation data relating to the tri-state bus, and
displaying the instrumentation data relating to the tri-state bus in response to the query.

13. A machine-accessible medium, which when accessed results in a machine performing operations comprising:
using a logic design element in a logic design;
performing a simulation of the logic design that includes simulating the logic design element; and
having the logic design element automatically collect instrumentation data during the simulation, wherein the instrumentation data relate to the logic design element.

14. The machine-accessible medium of claim 13 further comprising displaying the instrumentation data relating to the logic design element.

15. The machine-accessible medium of claim 14 further comprising receiving a query to display the instrumentation data relating to the logic design element, wherein displaying the instrumentation data includes displaying the instrumentation data relating to the logic design element in response to the query.

16. The machine-accessible medium of claim 14 wherein displaying the instrumentation data includes displaying the instrumentation data after performing the simulation.

17. The machine-accessible medium of claim 14 wherein displaying the instrumentation data includes displaying the instrumentation data while performing the simulation.

18. The machine-accessible medium of claim 14 wherein:
performing the simulation includes performing a partial simulation,
having the logic design element automatically collect the instrumentation data includes having the logic design element automatically collect the instrumentation data during the partial simulation, and
displaying the instrumentation data includes displaying the instrumentation data after performing the partial simulation.

19. The machine-accessible medium of claim 13 wherein:
the logic design element includes a FIFO memory, and
having the logic design element automatically collect the instrumentation data includes having the FIFO memory automatically collect the instrumentation data during the simulation, with the instrumentation data relating to the FIFO memory.

20. The machine-accessible medium of claim 19 wherein having the FIFO memory automatically collect the instrumentation data includes having the FIFO memory record usage of the FIFO memory during the simulation.

21. The machine-accessible medium of claim 19 further comprising:
receiving a query to display the instrumentation data relating to the FIFO memory, and
displaying the instrumentation data relating to the FIFO memory in response to the query.

22. The machine-accessible medium of claim 13 wherein:
the logic design element includes a tri-state bus, and
having the logic design element automatically collect the instrumentation data includes having the tri-state bus automatically collect instrumentation data during the simulation, with the instrumentation data relating to the tri-state bus.

23. The machine-accessible medium of claim 22 wherein having the tri-state bus automatically collect the instrumentation data includes having the tri-state bus automatically collect usage of the tri-state bus during the simulation.

24. The machine-accessible medium of claim 22 further comprising:
receiving a query to display the instrumentation data relating to the tri-state bus, and
displaying the instrumentation data relating to the tri-state bus in response to the query.

25. An apparatus comprising:
a simulation module that is structured and arranged to perform a simulation of a logic design that includes a logic design element; and
a collection module that is integrated with the logic design element and that is structured and arranged to automatically collect instrumentation data relating to the logic design element during the simulation.

26. The apparatus of claim 25 further comprising a display module that is structured and arranged to display the instrumentation data relating to the logic design element.

27. The apparatus of claim 26 further comprising an interface module that is structured and arranged to receive a query to display the instrumentation data relating to the design element, wherein the display module is structured and arranged to display the instrumentation data relating to the logic design element in response to the query.

28. The apparatus of claim 25 wherein:
the logic design element includes a FIFO memory, and
the collection module is integrated with the FIFO memory and is structured and arranged to automatically collect the instrumentation data relating to the FIFO memory during the simulation.

29. The apparatus of claim 25 wherein:
the logic design element includes a tri-state bus, and
the collection module is integrated with the tri-state bus and is structured and arranged to automatically collect the instrumentation data relating to the tri-state bus during the simulation.
